(19) United States
(12) Patent Application Publication
(10) Pub. No.: US 2024/0152196 A1
(43) Pub. Date: May 9, 2024

(54) SYSTEM AND METHODS FOR DISPLAY SYSTEM SLEEP MODES

(71) Applicant: TEXAS INSTRUMENTS INCORPORATED, Dallas, TX (US)

(72) Inventors: Natalia GARCIA, Carrollton, TX (US); Jeffrey Scott FARRIS, Flower Mound, TX (US); Mayee Dorris CHAO, Dallas, TX (US); Gregory Allen EDGAR, Fairview, TX (US)

(21) Appl. No.: 18/162,669

(22) Filed: Jan. 31, 2023

Related U.S. Application Data
(60) Provisional application No. 63/382,783, filed on Nov. 8, 2022.

(51) Int. Cl. G06F 1/324; G06F 1/3234; G06F 1/3287

(52) U.S. Cl. CPC G06F 1/324; G06F 1/3265; G06F 1/3287

(57) ABSTRACT

An apparatus includes a light modulator configured to modulate light to display frames of images based on display image data, and a controller coupled to the light modulator. The controller is configured to obtain a sequence of image data to be displayed by the light modulator; produce the display image data based on the sequence of image data; transmit the display image data to the light modulator; determine, based on the sequence of image data, to enter one or more sleep modes that reduce power usage by the controller, the light modulator, or an interface between the controller and the light modulator compared to a normal operation mode; and enter one or more extended sleep modes that have lower power usage than the one or more sleep modes if an extended sleep mode signal is detected in the sequence of image data.

### CROSS-REFERENCE TO RELATED APPLICATIONS

The present application claims priority to U.S. Provisional Patent Application No. 63/382,783, which was filed Nov. 8, 2022, is titled “System and Method for Light Modulator System Power Reduction Using Nested Sleep Modes,” and is hereby incorporated herein by reference in its entirety.

### BACKGROUND

Projection-based displays project images onto projection surfaces, such as onto a wall or a screen, to display video or pictures for viewing. Such displays can include cathode-ray tube (CRT) displays, liquid crystal displays (LCDs), and spatial light modulator (SLM) displays such as digital mirror device (DMD) displays, etc. Projection-based displays include near-eye displays for projecting image through the eye pupil on the retina, such as augmented reality (AR) or virtual reality (VR) displays in wearable devices.

### SUMMARY

In accordance with at least one example of the disclosure, an apparatus includes a light modulator configured to modulate light to display frames of images based on display image data, and a controller coupled to the light modulator. The controller is configured to obtain a sequence of image data to be displayed by the light modulator; produce the display image data based on the sequence of image data; transmit the display image data to the light modulator; determine, based on the sequence of image data, to enter one or more sleep modes that reduce power usage by the controller, the light modulator, or an interface between the controller and the light modulator compared to a normal operation mode; and enter one or more extended sleep modes that have lower power usage than the one or more sleep modes if an extended sleep mode signal is detected in the sequence of image data.

In accordance with at least one example of the disclosure, a method includes obtaining, by a controller from a processor, a sequence of image data to be displayed by a light modulator; entering, based on a gap length in the sequence of image data, sleep modes according to an order from higher to lower power usage; entering, if the sequence of image data includes a first control signal to power down, a powered down mode after entering the sleep modes, wherein the powered down mode has a lower power usage than the sleep modes; and entering, if the sequence of image data includes a second control signal to power down clocks, a clocks down mode after entering the powered down mode, wherein the clocks down mode has a lower power usage than the powered down mode.

In accordance with at least one example of the disclosure, a device includes a light modulator configured to modulate light to display frames of images based on display image data, one or more light sources configured to transmit the light, a processor configured to process received image data to produce a sequence of image data, and one or more controllers coupled to the light modulator, the one or more light sources, and the processor. The one or more controllers are configured to obtain, from the processor, the sequence of image data; control the light modulator and the light sources based on the sequence of image data comprising producing the display image data based on the sequence of image data and transmitting the display image data to the light modulator; enter, based on the sequence of image data, one or more sleep modes according to an order from higher to lower power usage, wherein the one or more sleep modes reduce power usage of the device compared to a normal operation mode; enter, if the sequence of image data includes a first control signal interpreted to power down, a powered down mode after entering the one or more sleep modes, wherein the powered down mode has a lower power usage than the one or more sleep modes; and enter, if the sequence of image data includes a second control signal interpreted to power down clocks, a clocks down mode after entering the powered down mode, wherein the clocks down mode has a lower power usage than the powered down mode.

### BRIEF DESCRIPTION OF THE DRAWINGS

FIG. 1 is a diagram of a display system, in accordance with various examples.

FIG. 2 is a flow diagram of a method for powering down a display system from a normal operation mode according to a number of sleep modes and extended sleep modes, in accordance with various examples.

FIG. 3 is a flow diagram of a method for entering nested sleep modes of a display system according to an order from higher to lower power usage.

FIG. 4 is a flow diagram of a method for exiting previously entered nested sleep modes of a display system according to an order from lower to higher power usage, in accordance with various examples.

FIGS. 5A to 5D are diagrams of cycles of sleep modes in a display system, in accordance with various examples.

FIG. 6 is a diagram of cycles of nested sleep modes for sequences of image data in regular time intervals, in accordance with various examples.

### DETAILED DESCRIPTION

Display systems, including projection-based displays, can be switched from a normal operation mode to a power saving mode to reduce power usage when the system is idle. For example, a display system can power down from a normal operation mode, during an inactive operation period, by entering a powered down operation mode to reduce power usage. For portable or wearable display systems that operate on battery power, such as portable projectors or AR/VR devices, reducing power usage is also useful to extend the battery lifetime.

In a display system that includes a light modulator for projecting images, such as a SLM (e.g., DMD, LCD, liquid crystal on silicon (LCoS), etc.), a phase light modulator (PLM) or a liquid crystal based light modulator, the light modulator is controlled by a controller through an interface for transmitting display image data. For example, the controller transmits the display image data on the interface to the light modulator based on low-voltage differential signaling (LVDS). During an inactive transmission period of display image data, such as when the display system does not project images, the interface between the controller and the light modulator can be powered down from a normal operation level to reduce power usage. When the display system projects images, the interface is maintained powered up at the normal operation level during an active transmission period of the display image data between the controller and the light modulator. Maintaining the interface powered up includes enabling the circuit blocks, clocks and/or buffers on both ends of the interface. Because the transmitted display image data can include gaps during the active transmission period, system functions can be idle during a portion of this time. Accordingly, maintaining the interface powered up at the normal operation level during the entire transmission period may not be needed and wastes system power.

This description includes examples of reducing the power usage of a display system by switching the system from a normal operation mode to a number of powered down operation modes, also referred to herein as sleep modes, in a certain order. The sleep modes are configured by switching off different components and/or functions of the display system to reduce power usage of the system to respective levels in comparison to the normal operation mode. The display system powers down to the levels of reduced power usage by entering respective sleep modes that are ordered from higher to lower power usage. The sleep modes that are arranged for powering down the system in the order from higher to lower power usage, are referred to herein as nested sleep modes. Accordingly, the system can further reduce power usage by entering a higher number of nested sleep modes.

The number of nested sleep modes and the respective reduced levels of power usage can be determined based on the pattern, including gaps, of received image data. For example, if the display image data produced based on the received image data includes a gap during an active transmission period, system functions may be idle during the gap time. During this idle time, the display system can be powered down by entering one or more sleep modes, in the order from higher to lower power usage, which reduce power usage in comparison to a normal operation mode. The system can then be powered up by exiting the nested sleep modes in the reverse order, from lower to higher power usage, until reaching the normal operation mode in time for transmitting a next data portion. Entering the nested sleep modes saves power in the system during an active transmission period of display image data. Entering and then exiting the nested sleep modes according to this order, also referred to herein as cycling through the nested sleep modes, allows timing the powering down and powering up of the system according to the traffic pattern in the received image data. For example, cycling through the nested sleep modes allows powering down components of the system during gaps in the traffic, and powering up the components in time to handle incoming data in the traffic. Entering and exiting the nested sleep modes also accounts for the duration of powering down and powering up, respectively, each of the nested sleep modes.

In examples, the controller obtains a next sequence of image data to be transmitted to the light modulator, such as a next portion of an image frame to be displayed. For example, an image frame can include a number of sequences of image data. In other examples, a sequence of image data represents an image frame, and a number of sequences of image data represent a number of image frames, such as in a video. The controller determines, based on the sequence of image data, the number of sleep modes with reduced power usage in idle time during the transmission of display image data. The idle time can include periods of inactive image data write activity to a buffer, periods of inactive image data read activity from a buffer, or periods of gaps in the display image data. The sequence of image data received from the processor can also include extended sleep mode signals identifying extended inactive periods that allow the system to enter extended sleep modes to further reduce power usage within the nested sleep modes.

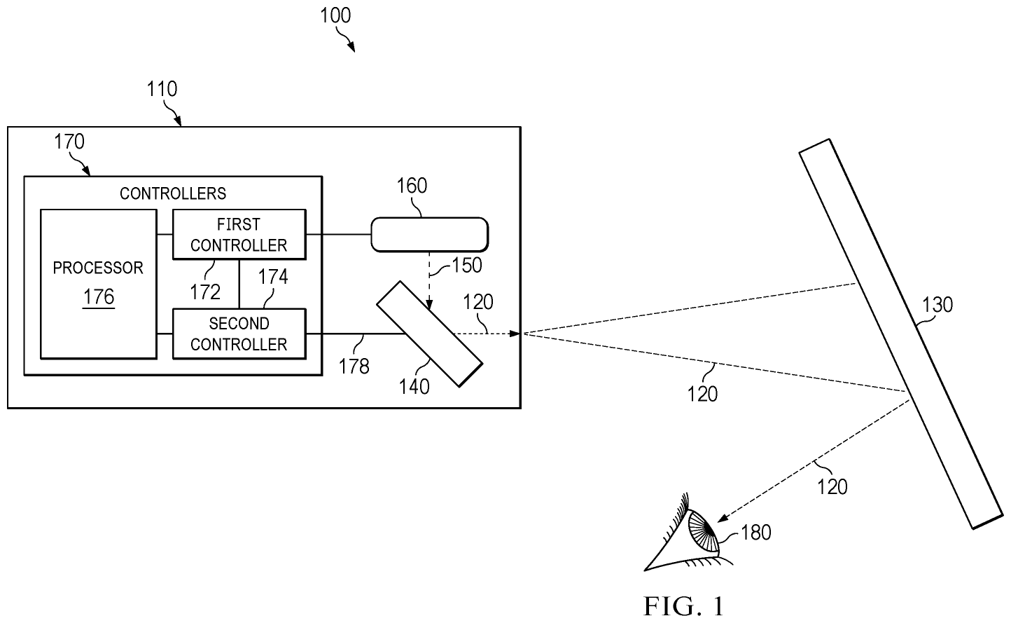

FIG. 1 is a diagram of a display system 100, in accordance with various examples. The display system 100 is a projection-based display that projects images or video for display. As shown in FIG. 1, the display system 100 includes a display device 110 which is configured to project a modulated light 120 onto an image projection surface 130 for displaying the images or video. For example, the image projection surface 130 can be a wall or a wall mounted screen. In other examples, the image projection surface 130 may be a screen of a heads up display (HUD), a projection surface in a vehicle such as a windshield, an outdoor environment such as a road, an augmented reality (AR) or virtual reality (VR) combiner, a three-dimensional (3D) display screen, or other display surfaces for projection-based display systems. In examples, the display system 100 is a portable projector or a wearable AR/VR device that can be powered by a battery with a limited power supply.

The modulated light 120 may be modulated by a light modulator 140 in the display device 110 to project images, such as video frames, onto the image projection surface 130. The light modulator 140 can be an electromechanical system (MEMS) based SLM, such as a digital mirror device (DMD), or a liquid crystal-based SLM, such as an LCD or LCoS device. The light modulator 140 modulates the intensity of the projected light based on optical elements that are controlled to manipulate the light and accordingly form the pixels of a displayed image. In examples, the light modulator 140 is a DMD, where the optical elements are adjustable tilting micromirrors that are tilted by applying voltages to the micromirrors through respective electrodes. The micromirrors are tilted to project dark pixels or bright pixels with color shades. In other examples, the light modulator 140 is an LCD or an LCoS device, where the optical elements are liquid crystals that are controlled by voltage to modulate the intensity of light across the image pixels. The intensity of light is modulated by applying voltage to the liquid crystals, which reorients the crystals, also referred to herein as switching the crystals, and accordingly controls the amount of light projected per pixel. The optical elements can be a transmissive array of liquid crystal cells such as in an LCD, or a reflective array of liquid crystal cells such as in an LCoS device. The cells of liquid crystals can be controlled by voltages, through respective electrodes, to modulate light.

In other examples, the light modulator 140 can be a phase light modulator (PLM) or a ferroelectric liquid crystal on silicon (FLCoS) device. A PLM can be a MEMS device including micromirrors that have adjustable heights with respect to the PLM surface. The heights of the micromirrors can be adjusted by applying voltages. The micromirrors may be controlled with different voltages to form a diffraction surface on the PLM. For example, each micromirror can be coupled to respective electrodes for applying a voltage and controlling the micromirror independently from the other micromirrors of the PLM. The diffraction surface is a phase altering reflective surface to light incident on the surface of the light modulator 140 from a light source. The phase altering reflective surface represents a hologram for projecting illumination patterns of light that form an image on an image projection surface. The hologram is formed as a diffraction surface by adjusting the heights of the micromirrors of the PLM. The hologram is formed based on an image that is to be displayed by projecting the light on the image projection surface 130. An FLCoS device includes ferroelectric liquid crystals (FLCs) that have a faster voltage response than other liquid crystal devices (e.g., LCDs and LCoS devices) and accordingly can project images at a higher rate. Other examples of the light modulator 140 include micro-light emitting diodes (micro-LEDs) and micro-organic light emitting diodes (micro-OLEDs).

The modulated light 120 can be formed as a combination of color modes (e.g., blue, green, and red) from an incident light 150, which is generated by one or more light sources 160. For example, three color modes can provide three basic color components for displaying an image in full color. The color modes in the incident light 150 can be transmitted concurrently or by time multiplexing the light sources 160. The incident light 150 with the different color modes is modulated by the light modulator 140 in the display device 110 to produce the modulated light 120 for displaying images or video on the image projection surface 130.

The display device 110 also includes one or more controllers 170 configured to control the light modulator 140 and the light sources 160 to display the images or video. For example, the controllers 170 can include a first controller 172 for controlling the light sources 160 to transmit the incident light 150 concurrently or consecutively by time multiplexing. The controllers 170 can also include a second controller 174 for controlling the light modulator 140 to modulate the incident light 150 from the respective light sources 160. In other examples, the display device 110 can include multiple light modulators 140 that each forms a respective modulated light 120. For example, each light modulator 140 can be optically coupled to a respective light source 160 and to the same controller 170 or respective controllers 170. The display device 110 also includes a processor 176 configured to process an image and produce a processed image for projection. The processed image can be a digital image, which is useful to provide control signals from the one or more controllers 170 to the light modulator 140 and the light sources 160. For example, the second controller 174 receives sequences of image data to be displayed from the processor 176. The sequences of image data can represent an image frame or a sequence of respective image frames to be displayed. The one or more controllers 170 produce display image data based on the sequences of image data, and transmits the display image data to the light modulator 140 on an interface 178. The one or more controllers 170 can provide control signals to the light modulator 140 based on the display image data. The light modulator 140 modulates the incident light 150 according to the control signals to display an image or a sequence of image frames, such as in a video, represented by the display image data. The light modulator 140 is configured to project the modulated light 120 on the image projection surface 130 to display the images for viewing by a human eye 180, also referred to herein as the human visual system (HVS) pupil. The display device 110 can further include one or more input/output devices (not shown), such as an audio input/output device, a key input device, a display, and the like. For example, the display device 110 is a wearable AR/VR device and the image projection surface 130 is an AR/VR combiner. The AR/VR device can include two AR/VR combiners for right and left eye viewing, respectively. Other examples of the display device 110 include displays such as LCDs, OLEDs, active-matrix OLEDs (AMOLEDs), for smartphones, tablets, laptops, and other portable devices.

The first controller 172 and the second controller 174 can be different controllers. The first controller 172 can be a digital controller configured to switch the light sources 160 on and off. In other examples, the first controller 172 can be an analog controller that changes the level of light intensity of the incident light 150 from the light sources 160. The analog controller can also transmit pulse width modulation (PWM) signals to the light modulator 140 to synchronize the adjustment of the optical elements in the light modulator 140 with the transmission of the incident light 150 from the light sources 160. The second controller 174 may be an analog or a digital controller that switches the optical elements of the light modulator 140. For example, the second controller 174 is an analog controller or a digital controller that switches the angles of micromirrors of an SLM or the heights of micromirrors of a PLM. In examples, the second controller 174 is a digital controller coupled to a static random access memory (SRAM) (not shown) including an array of memory cells each configured to store voltage values, such as in bits, to adjust respective micromirrors of an SLM or a PLM. The micromirrors can be adjusted according to the bit values in the corresponding SRAM cells, such as based on PWM signals from the first controller 172. In other examples, the light modulator 140 is an LCD, an LCoS device, or a FLCoS device and the optical elements are liquid crystals that are controlled by the second controller 174 to modulate the incident light 150 across the image pixels.

The one or more controllers 170 are also configured to process the sequences of image data received from the processor 176 to determine whether to power down the display device 110 from the normal operation mode to one or more nested sleep modes that are ordered from higher to lower power usage. The one or more controllers 170, such as the second controller 174, can analyze the pattern of the sequences of image data to identify when the display device 110 enters each of the determined nested sleep modes. For example, the controller 170 can enter or instruct the components of the display device 110 to enter, based on a gap length in the sequence of image data, sleep modes according to an order from higher to lower power usage. A controller 170 can determine according to the length of one or more gaps in a sequence of image data a timing to enter and exit each nested sleep mode. The timing of each nested sleep mode is determined by the controller 170 to reduce power usage during idle periods of the components of the display device 110, such as in the interface 178, the light modulator 140, or the one or more controllers 170. If longer idle periods or longer gaps in the data are expected, the display device 110 can enter more nested sleep modes to further reduce power usage. For each of the sleep modes, respective components and/or functions are switched off or disabled to provide a respective level of reduced power usage.

The processor 176 is also configured to add extended sleep mode signals in the image data received by the controller 170. The extended sleep mode signals in the image data indicate inactive display periods during the transmission of the display image data, which allow the components of the display device 110 to power down. A controller 170 detects the extended sleep mode signals and accordingly instructs the components of the display device 110 to enter one or more extended sleep modes. The extended sleep modes have lower power usage in comparison to other nested sleep modes.

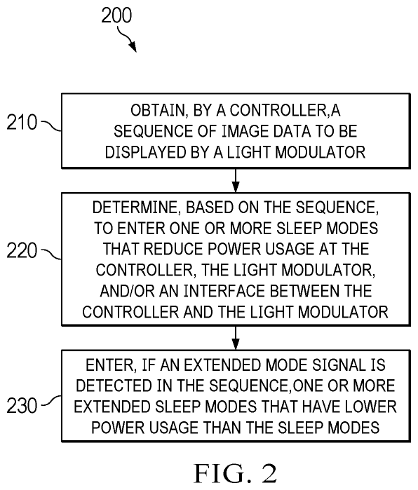

FIG. 2 is a flow diagram of a method 200 for powering down a display system from a normal operation mode according to a number of sleep modes and extended sleep modes, in accordance with various examples. The method 200 can be performed by the components of the display device 110 to reduce power usage during a transmission period of display image data. In examples, the method 200 is performed by a controller 170, such as the second controller 174, to instruct components of the display device 110, such as the interface 178, the light modulator 140, and the one or more controllers 170 to enter nested sleep modes.

At step 210, a controller 170 obtains a sequence of image data to be displayed by the light modulator 140. The sequence of image data can be generated by the processor 176 and sent as one of a number of sequences of image data to the controller 170. For example, the sequence of image data can be a portion of an image frame or a complete image frame to be displayed by the display device 110. At step 220, the controller 170 determines, based on the sequence of image data, to enter one or more sleep modes that reduce power usage of the controller 170, the light modulator 140, or the interface 178 in comparison to a normal operation mode. The controller 170 determines a number of nested sleep modes based on the pattern of the image data, such as the length and/or number of gaps in the image data. The controller 170 can instruct one or more components of the display device 110, such as the interface 178, the light modulator 140, and the one or more controllers 170 to enter a number of sleep modes. The controller 170 determines the number of nested sleep modes based on the pattern of the image data, such as the length and/or number of gaps in the image data. For example, the controller 170 can determine a length or a number of one or more gaps in a sequence of image data, and enters a number of sleep modes in proportion to the length or the number of the one or more gaps.

At step 230, the controller 170 enters, if an extended sleep mode signal is detected in the sequence of image data, one or more extended sleep modes that further reduce power usage within the nested sleep modes. The controller 170 detects the extended sleep mode signal in the sequence of image data received from the processor 176, and accordingly enters a respective extended sleep mode according to the order of nested sleep modes. The controller 170 enters the extended sleep mode after powering down the display device 110 through one or more sleep modes that have higher power usage and that are determined based on the pattern of the image data. In examples, the sequence of image data received from the processor 176 can include a number of extended sleep mode signals that identify respective extended sleep modes of different power usage. The controller 170 enters each respective extended sleep mode in response to detecting the respective extended sleep mode signal, according to an order from higher to lower power usage.

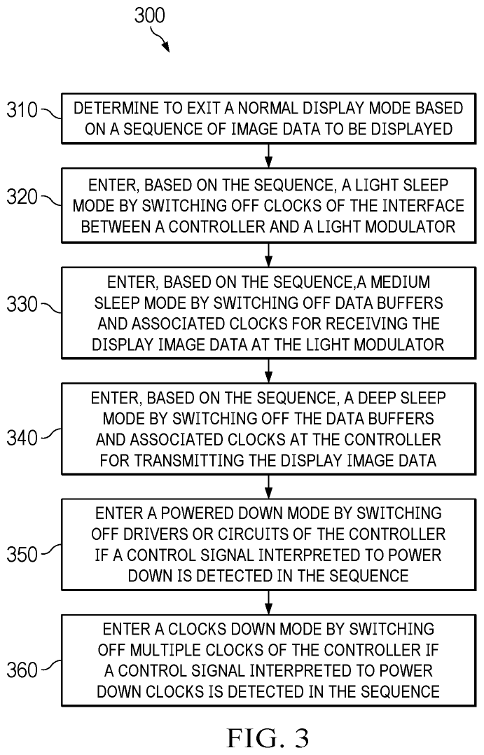

FIG. 3 is a flow diagram of a method 300 for entering nested sleep modes in a display system that are ordered from higher to lower power usage, in accordance with various examples. The nested sleep modes include sleep modes determined based on the pattern of a sequence of image data. The sleep modes include a light sleep mode, a medium sleep mode with lower power usage than the light sleep mode, and a deep sleep mode with lower power usage than the medium sleep mode. The nested sleep modes also include extended sleep modes indicated in the sequence of image data by respective extended sleep mode signals. The extended sleep modes include a powered down mode with lower power usage than the deep sleep mode, and a clocks down mode with lower power than the powered down mode.

The method 300 can be performed by the components of the display device 110 to reduce power usage during a transmission period of display image data. In examples, the method 300 is performed by a controller 170, such as the second controller 174, to instruct components of the display device 110, such as the interface 178, the light modulator 140, and the one or more controllers 170 to enter a number of nested sleep modes.

At step 310, the controller 170 determines to exit a normal operation mode based on a sequence of image data to be displayed. The sequence of image data can be received from the processor 176 and can include one or more gaps. The display image data is produced based on the sequence of image data and is sent on the interface 178 to the light modulator 140 during a transmission period in the normal operation mode. In the normal operation mode, the components and functions of the controller 170 and the light modulator 140, such as drivers or circuits, remain switched on. The controller 170 can predict respective gaps in the display image data based on the pattern of the sequence of image data. For example, the pattern of the sequence of image data is a compressed data pattern which produces gaps in the display image data that is transmitted to the light modulator 140. Before exiting the normal operation mode, the controller 170 completes loading the display image data of a previous sequence of image data received from the processor 176.

At step 320, the controller 170 enters, based on the sequence of image data, a light sleep mode by switching off clocks of the interface 178 between the controller 170 and the light modulator 140. Entering the light sleep mode reduces power usage of the display device 110 in comparison to the normal operation mode. In the light sleep mode, the display image data are not transmitted on the interface 178 and the components and functions of the controller 170 remain switched on. At step 330, the controller 170 enters, based on the sequence of image data, a medium sleep mode by switching off data buffers and associated clocks for receiving the display image data at the light modulator 140. For example, the controller 170 determines to power down from the light sleep mode to the medium sleep mode if a length of the gap in the display image is greater than a certain threshold, which allows a time to cycle through the light sleep mode and the medium sleep mode and to return to the normal operation mode to handle incoming next data. Because display image data is not transmitted on the interface 178 in the medium sleep mode, the buffers and associated clocks of the light modulator 140 can be switched off to further reduce power usage in comparison to the light sleep mode. The controller 170 can instruct the light modulator 140 to enter the medium sleep mode by signaling the light modulator 140 to switch off the buffers and clocks. The controller 170 can then wait for a certain delay time (e.g., on the order of hundreds of nanoseconds) for the powering down of the buffers and clocks of the light modulator 140 to enter the medium sleep mode. The components and functions (e.g., drivers or circuits) of the controller 170 remain switched on. In examples, the clocks for receiving the display image data at the light modulator 140 can be configured to switch off or to remain switched on during the medium sleep mode.

At step 340, the controller 170 enters, based on the sequence of image data, a deep sleep mode by switching off data buffers and associated clocks at the controller 170 for transmitting the display image data. For example, the controller 170 determines to power down from the medium sleep mode to the deep sleep mode if a length of the gap in the display image is greater than a certain threshold, which allows a time to cycle through the light sleep mode, the medium sleep mode, and the deep sleep mode and to return to the normal operation mode to handle incoming next data. Because the image data is not processed by the controller 170 in the deep sleep mode, the buffers and associated clocks for transmitting the display image data can be switched off to further reduce power usage in comparison to the medium sleep mode. The controller 170 can wait for a certain delay time (e.g., on the order of tens of nanoseconds) for powering down the buffers and clocks. The controller 170 can also wait another amount of time that is determined based on the sequence of image data, such as based on a compression rate in the sequence of image data. In examples, the clocks at the controller 170 for transmitting the display image data can be configured to switch off or to remain switched on during the deep sleep mode. During the normal operation mode, the light sleep mode, the medium sleep mode, and the deep sleep mode, the light modulator 140 can be in an active display period for displaying the display image data. A device driver interface can remain active during the normal operation mode and higher power usage sleep modes to issue commands to the components of the display device 110. In lower power usage sleep modes, the buffers associated with the device driver interface can be disabled which deactivates the device driver interface.

In examples, the sequence of image data is fetched and compressed based on the pattern of the imaged data before writing the data into a buffer of the controller 170. The compressed data is then read from the buffer to produce display image data that is transmitted on the interface 178 to the light modulator 140. The controller 170 can set one or more configuration bits for sleep control to enable entering the deep sleep mode, the medium sleep mode, and/or the light sleep mode, respectively, based on the pattern of the image data. If a configuration bit for sleep control is not set, the components of the display device 110 are not enabled to enter a respective sleep mode in response to a request from the controller 170. The configuration bits can indicate to the controller 170 the sleep modes that are enabled and the times to enter and exit the sleep modes.

At step 350, the controller 170 enters a powered down mode by switching off drivers or circuits of the controller 170 if a control signal to power down is detected in the sequence of image data. The control signal can be added to the sequence of image data by the processor 176 before sending the sequence of image data to the controller 170. The control signal can indicate a start of an inactive display driver transmission segment, such as in the absence of data between two portions of display image data. For example, the light modulator 140 can project a dark image during an inactive display driver transmission segment, such as between two portion of an image frame or between two image frames. An inactive display driver transmission segment can occur during a certain gap time in the image data that exceeds a threshold. In other examples, the inactive display driver transmission segment represents a period of time during which the optical elements of the light modulator 140 are switched to project dark pixels. For example, the micromirrors of a DMD are tilted to project dark pixels during the period of an inactive display driver transmission segment. In examples, the sequence of image data can include a control signal to power down which indicates a start of the inactive display driver transmission segment and a control signal to power up which indicates the end of the inactive display driver transmission segment. In examples, the same control signal in the sequence of image data can be interpreted by the controller 170 to power down if the components of the display device 110 are in the deep sleep mode or to power up if the components are in the power down mode. In other examples, the control signal to power down by the controller 170 is different than the control signal to power up. The controller 170 enters the powered down mode if the controller 170 is already in the deep sleep mode. If the display device 110 includes multiple light modulators 140, then the controller 170 can enter the powered down mode if each of the light modulators 140 is in a deep sleep mode. In examples, the controller 170 is enabled to enter the powered down mode if a respective configuration bit for sleep control is set. After entering the powered down mode, the controller 170 can wait in the powered down mode an amount of time that is determined based on the sequence of image data, such as based on the compression rate in the image data. For example, the wait time can be greater than a thousand nanoseconds.

At step 360, the controller 170 enters a clocks down mode by switching off multiple clocks of the controller 170 if a control signal that is interpreted by the controller 170 to power down clocks is detected in the sequence of image data. In examples, the controller 170 switches off a write clock, a multiplexer clock, and a control clock in response to detecting the control signal. Other clocks, such as a video clock, sequence controller clocks can remain switched on. For example, clocks that control the circuit logic to exit the clocks down mode remain switched on. The controller 170 can also enter a clocks down mode by both switching off multiple clocks and shutting down multiple functions of the controller 170 or other controllers 170. The control signal can be added to the sequence of image data by the processor 176 before sending the sequence of image data to the controller 170. The control signal to power down clocks can indicate a start of an image processing off period, and can be added in the image data after a control signal to power down which indicates the start of the inactive display driver transmission segment. An image processing off period can follow an inactive display driver transmission segment in the image data. In examples, the sequence of image data can include a control signal interpreted to power down clocks at a start of the image processing off period and a control signal interpreted to power up the clocks at the end of the image processing off period. In examples, the same control signal in the sequence of image data can be interpreted by the controller 170 to power down clocks if the components of the display device 110 are in the power down mode or to power up if the components are in the clocks down mode. In other examples, the control signal to power down clocks by the controller 170 is different than the control signal to power up the clocks. During this period, the display device 110 may not be processing image data by the controllers 170 or displaying image data by the light modulator 140. If image data is not processed or displayed in this period, multiple clocks of the controller 170 can be switched off to further reduce power usage in comparison to the powered down mode.

The controller 170 enters the clocks down mode if the controller 170 is already in the powered down mode. In examples, the controller 170 is enabled to enter the clocks down mode if a respective configuration bit is set for sleep control. After entering the clocks down mode, the controller 170 can also wait an amount of time that is determined based on the sequence of image data. For example, the wait time can be on the order of thousands of nanoseconds. The controller 170 can also wait in the clocks down mode until detecting a signal indicating an incoming next received sequence of image data (e.g., next image frame or next image frame portion). The controller 170 exits the clocks down mode in response to detecting the signal of an incoming sequence of image data. During the extended sleep modes, which include the powered down mode and the clocks down mode, the controller 170 and the light modulator 140 can be in an inactive image processing and display mode. A device driver interface can also be inactive during the extended sleep modes. The processor 176 or another controller of the display device 110 is configured to time the extended sleep mode signals, which include the control signal interpreted to power down or power up and the control signal interpreted to power down or power up the clocks, according to the inactive display driver transmission segments in the image data and the image processing off periods expected in the display device 110. The extended sleep modes are timed to account for the duration to power down and power up the display device 110 in the display image data.

In examples, the nested sleep modes, including the extended sleep modes, are programmable for different power usage based on configurable parameters that determine respective functions of the components of the display device 110. For example, parameters for enabling and disabling respective clocks, buffers, drivers, or circuits of the controller 170, the light modulator 140, and/or the interface 178 can be set to enter a sleep mode or an extended sleep mode with a certain level of power usage. The parameters can be set, such as by respective configuration bits for sleep control, to enable certain clocks and/or buffers which determine the level of power usage. For example, parameters can be set to select certain respective clocks to disable in the clocks down mode, or to disable clocks without the buffers in the deep sleep mode or the medium sleep mode.

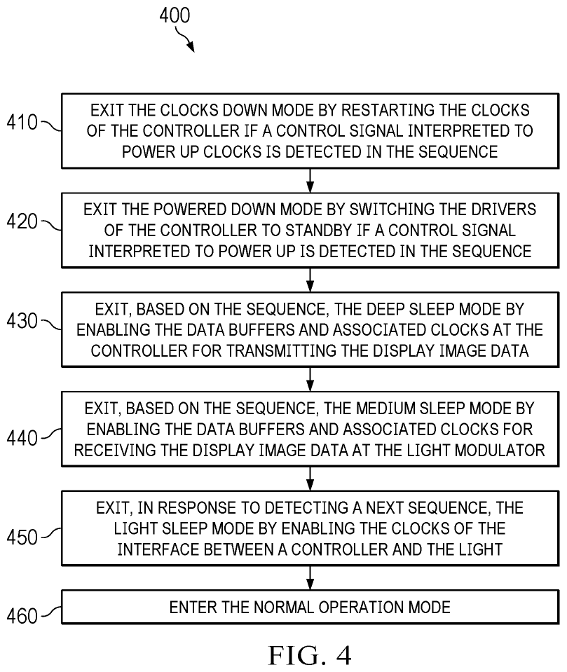

After entering a number of nested sleep modes in the order from higher to lower power usage, the display system is configured to power up though the nested modes in the reverse order to reach a normal operation mode. FIG. 4 is a flow diagram of a method 400 for exiting previously entered nested sleep modes in a display system according to an order from lower to higher power usage, in accordance with various examples. The entered nested sleep modes include sleep modes determined based on the pattern of a sequence of image data, such as the light sleep mode, the medium sleep mode, and the deep sleep mode. The nested sleep modes also include extended sleep modes indicated in the sequence of image data by respective extended sleep mode signals, such as the powered down mode and the clocks down mode.

The method 400 can be performed by the components of the display device 110. A controller 170, such as the second controller 174, can instruct the components of the display device 110, such as the interface 178, the light modulator 140, and the one or more controllers 170 to exit a number of nested sleep modes after entering the nested sleep modes to reduce power usage during a transmission period of display image data. The method 400 is performed after the components of the display device 110 enter the clocks down mode. At step 410, the controller 170 exits the clocks down mode by restarting clocks of the controller 170 if a control signal interpreted to power up clocks is detected in the sequence of image data. For example, the restarted clocks include a write clock, a multiplexer clock, and a control clock. The control signal to exit the clocks down mode can be added to the sequence of image data by the processor 176 before sending the sequence of image data to the controller 170. The control signal can be added in the sequence of image data after a control signal interpreted to power down the clocks. For example, the control signal interpreted to power up the clocks is added in the sequence of image data in time with the end of an image processing off period. Before exiting the clocks down mode, the controller 170 can also wait an amount of time that is determined based on the sequence of image data. For example, the wait time can be greater than a thousand nanoseconds. The controller 170 can also wait in the clocks down mode until detecting a signal indicating an incoming next sequence of image data (e.g., next image frame or next frame portion) and exits the clocks down mode in response to detecting the signal. The controller 170 is configured to wake up the clocks in time for receiving the next sequence of image data.

The controller 170 enters the powered down mode after exiting the clocks down mode. At step 420, the controller 170 exits the powered down mode by switching the drivers or circuits of the controller 170 to standby if a control signal interpreted to power up is detected in the sequence of image data. In the standby state, the drivers or circuits are powered and ready to operate for processing a next sequence of image data, which reduces a delay to start this processing. The control signal to power up and exit the powered down mode can be added to the sequence of image data by the processor 176 before sending the sequence of image data to the controller 170. The control signal can be added in the sequence of image data after a control signal interpreted to power down the controller 170. The control signal interpreted to power up the controller 170 is added in the sequence of image data in time with the end of the image processing off period. Before exiting the powered down mode, the controller 170 can wait to exit the powered down mode an amount of time to stabilize the operation of the drivers. For example, the wait time can be close to a thousand nanoseconds. The control signal interpreted to power up clocks and exit the powered down mode is timed by the processor 176 or another controller of the display device 110 to power up the drivers in time for receiving the next sequence of image data.

In examples, the processor 176 adds both a control signal to power up clocks and a control signal to power up the controller 170 at or near the start of a first sequence in a number of sequences of image data to confirm the enabling of the clocks and buffers of the controller 170, respectively, before handling the sequences of image data. The processor 176 can add the control signal to power up clocks at the start of a first sequence in the sequences of image data and add the control signal to power up the controller 170 with the buffers before a first active processing period of the first sequence.

The controller 170 enters the deep sleep mode after exiting the powered down mode. At step 430, the controller 170 exits, based on the sequence of image data, the deep sleep mode by enabling the data buffers and associated clocks at the controller 170 for transmitting the display image data. For example, the controller 170 powers up from the deep sleep mode to the medium sleep mode by switching on the buffers and associated clocks for transmitting the display image data in time to process incoming image data by the controller 170. Before exiting the deep sleep mode, the controller 170 can wait an amount of time to stabilize input and output for transmitting the display image data. For example, the wait time can be less or equal to a thousand nanoseconds.

The controller 170 enters the medium sleep mode after exiting the deep sleep mode. At step 440, the controller 170 exits, based on the sequence of image data, the medium sleep mode by enabling the data buffers and associated clocks for receiving the display image data at the light modulator 140. For example, the controller 170 powers up from the medium sleep mode to the light sleep mode by switching on the buffers and associated clocks for receiving the display image data in time to display incoming image data by the light modulator 140. Before exiting the medium sleep mode, the controller 170 can wait an amount of time to power up the clocks for receiving the display image data at the light modulator 140. For example, the wait time can be on the order of hundreds of nanoseconds.

The controller 170 enters the light sleep mode after exiting the medium sleep mode. At step 450, the controller 170 exits, based on the sequence of image data, the light sleep mode by enabling the clocks of the interface 178 between the controller 170 and the light modulator 140. For example, the controller 170 powers up from the light sleep mode to the normal operation mode by switching on the clocks of the interface 178 in time to transmit display image data from the controller 170 to the light modulator 140. The controller 170 can exit the light sleep mode in response to detecting a request from the light modulator 140 to load display image data. In response to the load request, the controller 170 releases a clock gate associated with the interface 178 to activate the clock.

At step 460, the controller 170 enters the normal operation mode. Before entering the normal operation mode, the controller 170 can wait an amount of time equal to a certain number of cycles of the activated clock. For example, the wait time can be close to ten or twenty cycles. In the normal operation mode, the controller 170 loads the display image data onto the light modulator 140.

The method 300 and 400 can be useful to power down the display device 110 from the normal operation mode and then power up the display system 100 to the operation mode by cycling through a number of nested sleep modes. In examples, the number of nested sleep modes can depend on the sequences of image data during a transmission period to the light modulator 140. For example, for larger gaps in the sequences of image data, the components of the display device cycle through a larger number of nested sleep modes. The nested sleep modes can also include extended sleep modes, such as for compressed image data that include larger gaps in comparison to uncompressed data or data compressed at lower rates. Increasing the number of nested sleep modes further reduces the power usage of the display device 110 compared to the normal operation mode.

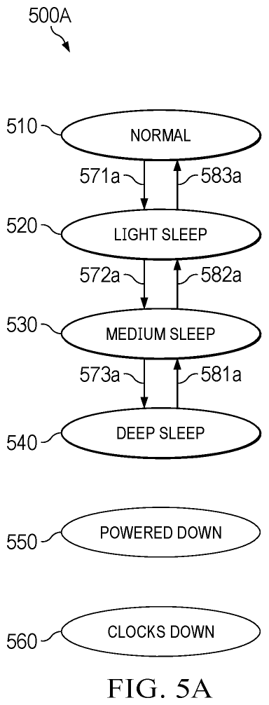

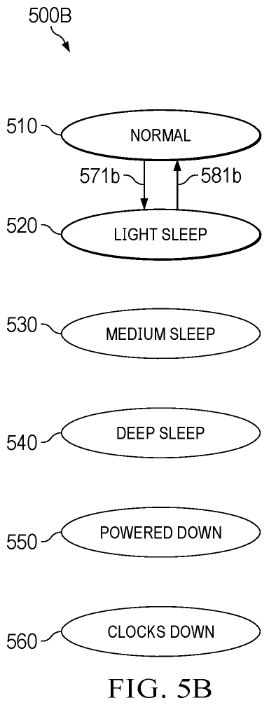

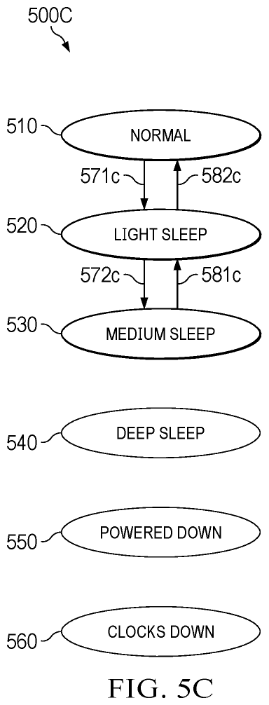

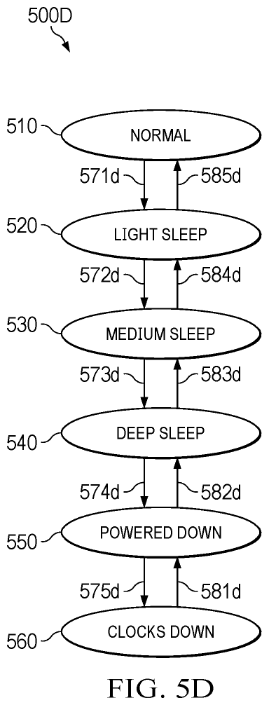

FIGS. 5A to 5D are diagrams of cycles of sleep modes in a display system, in accordance with various examples. FIG. 5A is a diagram of a first cycle 500A of nested sleep modes to power down a display device of the display system, such as the display device 110, from a normal operation mode 510 and then power up the display device to the normal operation mode 510. The nested sleep modes include a light sleep mode 520, a medium sleep mode 530, and a deep sleep mode 540. For example, a controller 170 instructs the components of the display device 110 (e.g., the interface 178, the light modulator 140, and the one or more controller 170) to perform power down procedures through the nested sleep modes to reduce power usage. The power down procedures include a first power down 571a from the normal operation mode 510 to the light sleep mode 520, a second power down 572a from the light sleep mode 520 to the medium sleep mode 530, and a third power down 573a from the medium sleep mode 530 to the deep sleep mode 540.

The sleep modes can be determined by the controller 170 based on the pattern of received image data, such as based on the length and/or number of gaps in one or more sequences of image data received from the processor 176. For example, the controller 170 determines entering more sleep modes for sequences of data that include more gaps. The controller 170 also determines entering more sleep modes for sequences of data that include longer gaps. If the controller 170 does not detect an extended sleep mode signal in the one or more sequences of image data, the controller 170 does not instruct the components of the display device 110 to enter extended sleep modes, which include the powered down mode 550 and the clocks down mode 560. After a certain time in the deep sleep mode, the controller 170 instructs the components of the display device 110 to perform power up procedures through the previously entered sleep modes in the reverse order to return to the normal operation mode 510. The power up procedures include a first power up 581a from the deep sleep mode 540 to the medium sleep mode 530, a second power up 582a from the medium sleep mode 530 to the light sleep mode 520, and a third power up 583a from the light sleep mode 520 to the normal operation mode 510.

FIG. 5B is a diagram of a second cycle 500B of nested sleep modes to power down and power up a display device. The second cycle 500B includes a single sleep mode based on the pattern of one or more sequences of image data from the processor 176. For example, if the length and/or number of gaps in a received sequence of image data is below a certain threshold, the controller 170 does not instruct the components of the display device 110 to enter the medium sleep mode 530. Accordingly, the components of the display device 110 perform a power down procedure 571b from the normal operation mode 510 to the light sleep mode 520 and perform a power up procedure 581b from the light sleep mode 520 to the normal operation mode 510 in time to transmit a next portion of display image data to the light modulator 140.

FIG. 5C is a diagram of a third cycle 500C of nested sleep modes to power down and power up a display device. Because the first cycle 500A includes more nested sleep modes than the third cycle 500C, the first cycle 500A further reduces power usage in the display device in comparison to the third cycle 500C. The third cycle 500C includes the light sleep mode 520 and the medium sleep mode 530. For example, a controller 170 instructs the components of the display device 110 to perform power down procedures through the light sleep mode 520 and the medium sleep mode 530 based on the length and/or number of gaps in one or more sequences of image data from the processor 176. The power down procedures include a first power down 571c from the normal operation mode 510 to the light sleep mode 520 and a second power down 572c from the light sleep mode 520 to the medium sleep mode 530. In examples, if the length and/or number of gaps is below a certain threshold, the controller 170 does not enter the deep sleep mode 540. The controller 170 then instructs the components of the display device 110 to perform power up procedures through the previously entered sleep modes to return to the normal operation mode 510. The power up procedures include a first power up 581c from the medium sleep mode 530 to the light sleep mode 520 and a second power up 582c from the light sleep mode 520 to the normal operation mode 510.

FIG. 5D is a diagram of a fourth cycle 500D of nested sleep modes to power down and power up a display device. Because the fourth cycle 500D includes more nested sleep modes than the first cycle 500A, the fourth cycle 500D further reduces power usage in the display device in comparison to the first cycle 500A. The nested sleep modes include the light sleep mode 520, the medium sleep mode 530, and the deep sleep mode 540. The fourth cycle 500D also includes the powered down mode 550 and the clocks down mode 560, which are extended sleep modes. For example, the controller 170 instructs, based on gaps in the received image data, the components of the display device 110 to perform power down procedures through the fourth cycle 500D of nested sleep modes. The power down procedures include a first power down 571d from the normal operation mode 510 to the light sleep mode 520, a second power down 572d from the light sleep mode 520 to the medium sleep mode 530, and third power down 573d from the medium sleep mode 530 to the deep sleep mode 540. In response to detecting extended sleep mode signals in the received sequence of image data, the controller 170 performs further power down procedures, which include a fourth power down 574d from the deep sleep mode 540 to the powered down mode 550 and a fifth power down 575d from the powered down mode 550 to the clocks down mode 560. After a wait time in the clocks down mode 560, the controller 170 instructs the components of the display device 110 to perform power up procedures through the previously entered sleep modes to return to the normal operation mode 510. The power up procedures include a first power up 581d from the clocks down mode 560 to the powered down mode 550, a second power up 582d from the powered down mode 550 to the deep sleep mode 540, a third power up 583d from the deep sleep mode 540 to the medium sleep mode 530, a fourth power up 584d from the medium sleep mode 530 to the light sleep mode 520, and a fifth power up 585d from the light sleep mode 520 to the normal operation mode 510. The extended sleep mode signals in a received sequence of image data are timed to allow the powering down and powering up of the components of the display device 110 before handling the next received sequence or portion of image data. In other examples, the display device 110 can power down from the normal operation mode 510 to the powered down mode 550 and then power up to the normal operation mode 510 in a cycle of nested sleep modes without the clocks down mode 560.

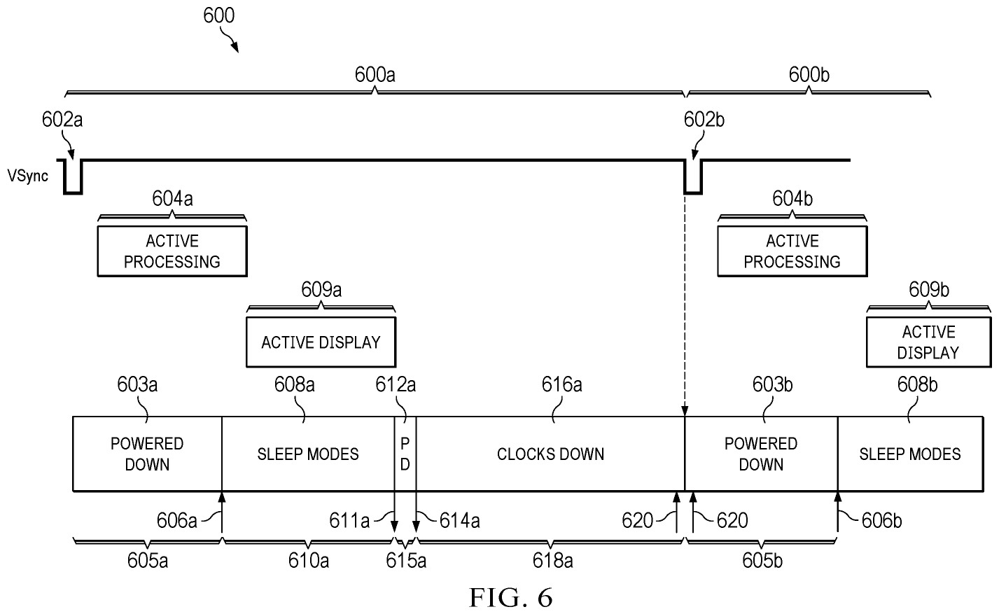

FIG. 6 is a diagram of cycles of nested sleep modes for sequences of image data obtained in regular respective regular time intervals in accordance with various examples. The sequences of image data are received by components of a display device in regular respective intervals 600. A sequence of image data can be a portion of an image frame or a complete image frame to be displayed by the display device 110. The start of each of the intervals 600 is signaled by a respective synchronization (e.g., a video synchronization (VSync) signal) signal useful to synchronize an image frame rate for displaying the image frames. For example, the start of an interval 600a is signaled by a respective video synchronization signal 602a. At the time of receiving the video synchronization signal 602a, a controller 170 of the display device is in a powered down mode 603a. In response to detecting the video synchronization signal 602a, a sequence of image data is obtained, processed, and stored in one or more buffers as write side activity during an active processing period 604a. The processing of the image data can include formatting and/or compressing the image data to produce display image data according to a certain format.

After an extended gap time 605a, the controller 170 in the powered down mode 603a detects a control signal 606a to power up in the sequence of image data, which triggers a power up response (shown by an upward arrow in FIG. 6). Accordingly, the controller 170 exits the powered down mode 603a and instructs the components of the display device 110 (e.g., the interface 178, the light modulator 140, and the one or more controllers 170) to power up to a normal operation mode. The controller 170 performs power up procedures from the powered down mode 603a to the normal operation mode by powering up the components of the display device 110 through a number of sleep modes 608a that are ordered from lower to higher power usage. The sleep modes 608a include a deep sleep mode, a medium sleep mode, and a light sleep mode. After powering up from the powered down mode 603a, the controller 170 switches to a ready state to display image data. The power up procedures also activate the light modulator 140 to project the display image data during an active display period 609a after the active processing period 604a. During this period, the controller 170 also performs read side activity to load the display image data from the one or more buffers to the light modulator 140. According to the timing of the control signal 606a, the controller 170 starts powering up the components of the display device 110 before the active display period 609a.

The controller 170 can also determine, based on the pattern in the image data, a time to exit the normal operation mode and accordingly instructs the components of the display device 110 to power down from the normal operation mode. For example, the controller 170 instructs the components of the display device 110 to power down to the deep sleep mode according to the length and/or number of gaps in the data. The controller 170 performs power down procedures to power down the components of the display device 110 from the normal operation mode to the deep sleep mode by entering the sleep modes 608a according to an order from higher to lower power usage. According to the instructions of the controller 170, the components of the display device 110 cycle between the normal operation mode and the deep sleep mode in a cycle time 610a. During the cycle time 610a, the light modulator 140 can remain active to project the display image data.

After the cycle time 610a, the controller 170 in the deep sleep mode detects a control signal 611a to power down in the sequence of image data, which triggers a power down response (shown by a downward arrow in FIG. 6). Accordingly, the controller 170 further powers down from the deep sleep mode to a second powered down mode 612a. The second power down mode 612a can indicate an inactive display driver transmission segment in the sequences of image data. According to the timing of the control signal 611a, the controller 170 enters the second powered down mode 612a after the active display period 609a. In examples, the processor 176 is configured to add the control signal 606a to power up in the sequence of image data according to an expected start time of the active display period 609a for displaying a next display image data. The processor 176 also adds the control signal 611a to power down in the sequence of image data according to an expected end time of the active display period 609a.

The controller 170 in the second powered down mode 612a then detects a control signal 614a to power down clocks in the sequence of image data after an extended gap time 615a, which triggers a power down response (shown by a downward arrow in FIG. 6). Accordingly, the controller 170 further powers down from the second powered down mode 612a to a clocks down mode 616a starting an image processing off period 618a. The controller 170 in the clocks down mode 616a then detects a control signal 620 to power up clocks in the sequence of image data, which triggers an upward response (shown by an upward arrow in FIG. 6). Accordingly, the controller 170 powers up from the clocks down mode 616a to a next powered down mode 603b ending the image processing off period 618a. For example, the processor 176 can add the control signal 620 to the end of a last sequence of image data in a first image frame. For redundancy, the processor 176 can further add the control signal 620 to the start of a first sequence of image data in a second image frame after the first image frame. The redundancy of the control signal 620 in two image frames allows detecting the control signal 620 if processing one of the two image frames is aborted.

The controller 170 in the clocks down mode 616a can also power up from the clocks down mode 616a to the next powered down mode 603b in response to detecting a next video synchronization signal 602b, which indicates the start of a next interval 600b for a next sequence of image data. Similar to the interval 600a, the next sequence of image data is obtained and processed in the next interval 600b producing display image data during an active processing period 604b after detecting the next video synchronization signal 602b. In examples, the processor 176 is configured to add the control signal 614a to power down clocks in the sequence of image data according to an expected end time of the active display period 609a in the interval 600a and to add the control signal 620 to power up clocks according to an expected start time of the active processing period 604b in the next interval 600b.

After an extended gap time 605b, the controller 170 detects a control signal 606b to power up in the next sequence of image data, and accordingly exits the powered down mode 603b to power up the components of the display device 110 to a normal operation mode through a number of sleep modes 608b. After powering up, the controller 170 can perform write side activity to store the received sequence of image data to one or more buffers. The light modulator 140 is then activated to project the display image data during an active display period 609b. The controller 170 also performs read side activity to load the display image data from the one or more buffers to the light modulator 140. The cycles of nested sleep modes can be repeated with processing and displaying next sequences of image data in next time intervals.

As shown in FIG. 6, the write side activity and the read side activity can be performed within a single interval 600 (e.g., indicated by the same VSync signal) for processing and displaying a sequence of image data (e.g., an image frame or a portion of an image frame). For example, the write side activity and the read side activity for a single image frame can be performed during the active processing period 604a and the active display period 609a, respectively, in the same interval 600a. Performing both activities within the same interval of an image frame reduces latency of processing and displaying image frames in the display device 110 in comparison to writing and reading an image frame in separate intervals. In other examples, a single sequence of image data includes more than one image frame, which can be processed and displayed within a same interval 600.

The durations of the active processing period 604a and the active display period 609a in the interval 600a also determine the remaining inactive time in the same interval that can be useful to power down, in an extended sleep mode, the components of the display device 110. For example, if the active display period 609a is shorter in the interval 600a than the interval 600b, the image processing off period 618a for the clocks down mode 616a and/or the extended gap time 615a for the second powered down mode 612a can be longer in comparison to the interval 600b. Increasing the duration of the extended sleep mode within the same interval 600a in comparison to the interval 600b, such as the clocks down mode 616a and/or the second powered down mode 612a, decreases the power usage in the display device 110.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be coupled to at least some of the passive elements and/or the sources to form the described structure either at a time of manufacture or after a time of manufacture, for example, by an end-user and/or a third-party.

While certain components may be described herein as being of a particular process technology, these components may be exchanged for components of other process technologies. Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground voltage potential” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter. Modifications are possible in the described examples, and other examples are possible within the scope of the claims.

What is claimed is:

1. An apparatus, comprising:
a light modulator configured to modulate light to display frames of images based on display image data;
a controller coupled to the light modulator and configured to:
obtain a sequence of image data to be displayed by the light modulator;
produce the display image data based on the sequence of image data;
transmit the display image data to the light modulator;
determine, based on the sequence of image data, to enter one or more sleep modes that reduce power usage by the controller, the light modulator, or an interface between the controller and the light modulator compared to a normal operation mode; and
enter one or more extended sleep modes that have lower power usage than the one or more sleep modes if an extended sleep mode signal is detected in the sequence of image data.

2. The apparatus of claim 1, wherein the one or more extended sleep modes include a powered down mode and a clocks down mode that has a lower power usage than the powered down mode, wherein the extended sleep mode signal is a control signal to power down the controller or to power down clocks, and wherein the controller is further configured to:
enter the powered down mode by switching off drivers or circuits of the controller if the control signal to power down is detected in the sequence of image data; and
enter the clocks down mode by switching off clocks of the controller if the control signal to power down clocks is detected in the sequence of image data.

3. The apparatus of claim 1, wherein the one or more sleep modes include a light sleep mode, a medium sleep mode that has a lower power usage than the light sleep mode, and a deep sleep mode that has lower power usage than the medium sleep mode, and wherein the controller is further configured to:
enter the light sleep mode by switching off first clocks of the interface between the controller and the light modulator;
enter the medium sleep mode by switching off first data buffers and associated second clocks for receiving the display image data at the light modulator; and
enter the deep sleep mode by switching off second data buffers and associated third clocks at the controller.

4. The apparatus of claim 3, wherein the controller is further configured to wait in the deep sleep mode an amount of time based on the sequence of image data.

5. The apparatus of claim 1, wherein the sequence of image data is a sequence of data that represents a frame to be displayed by the light modulator, and wherein the sequence of data includes one or more gaps in the data.

6. The apparatus of claim 5, wherein the controller is further configured to enter the one or more sleep modes based on a length of the one or more gaps in the sequence of data.

7. The apparatus of claim 5, wherein the one or more gaps are produced by data compression in the sequence of data.

8. The apparatus of claim 1, wherein the one or more extended sleep modes are programmable for different power usage based on configurable of parameters for enabling and disabling clocks, buffers, drivers, or circuits of the controller, the light modulator, or the interface.

9. A method comprising:
obtaining, by a controller from a processor, a sequence of image data to be displayed by a light modulator;
entering, based on a gap length in the sequence of image data, sleep modes according to an order from higher to lower power usage;
entering, if the sequence of image data includes a first control signal to power down, a powered down mode after entering the sleep modes, wherein the powered down mode has a lower power usage than the sleep modes; and
entering, if the sequence of image data includes a second control signal to power down clocks, a clocks down mode after entering the powered down mode, wherein the clocks down mode has a lower power usage than the powered down mode.

10. The method of claim 9, further comprising:
entering the powered down mode by switching off drivers or circuits of the controller; and
entering the clocks down mode by switching off multiple clocks of the controller or by both switching off the clocks and shutting down multiple functions of the controller.

11. The method of claim 10, further comprising:
before entering the clocks down mode, waiting in the powered down mode a first amount of time based on the sequence of image data; and
waiting in the clocks down mode a second amount of time based on the sequence of image data or until detecting a signal indicating a next sequence of image data to be displayed.

12. The method of claim 10, further comprising:
exiting the clocks down mode by restarting the clocks of the controller if a third control signal interpreted to power up clocks is detected in the sequence of image data; and
exiting the powered down mode by switching the drivers or circuits to standby if a fourth control signal interpreted to power up is detected in the sequence of image data.

13. The method of claim 12 further comprising before exiting the clocks down mode, waiting an amount of time based on the sequence of image data.

14. The method of claim 12, wherein the first control signal to power down indicates a start of an inactive display driver transmission segment in the sequence of image data, wherein the fourth control signal to power up indicates an end of the inactive display driver transmission segment, wherein the second control signal to power down clocks indicates a start of an image processing off period, and wherein the third control signal to power up clocks indicates an end of the image processing off period.

15. The method of claim 9, further comprising exiting the sleep modes, the powered down mode, and the clocks down mode according to an order of modes from lower to higher power usage.

16. A device comprising:
a light modulator configured to modulate light to display frames of images based on display image data;
one or more light sources configured to transmit the light;
a processor configured to process received image data to produce a sequence of image data; and
one or more controllers coupled to the light modulator, the one or more light sources, and the processor and configured to:
obtain, from the processor, the sequence of image data;
control the light modulator and the light sources based on the sequence of image data comprising producing the display image data based on the sequence of image data and transmitting the display image data to the light modulator;
enter, based on the sequence of image data, one or more sleep modes according to an order from higher to lower power usage, wherein the one or more sleep modes reduce power usage of the device compared to a normal operation mode;
enter, if the sequence of image data includes a first control signal interpreted to power down, a powered down mode after entering the one or more sleep modes, wherein the powered down mode has a lower power usage than the one or more sleep modes; and
enter, if the sequence of image data includes a second control signal interpreted to power down clocks, a clocks down mode after entering the powered down mode, wherein the clocks down mode has a lower power usage than the powered down mode.

17. The device of claim 16, wherein the one or more controllers are further configured to:
exit the clocks down mode if a third control signal to power up clocks is detected in the sequence;
exit the powered down mode if a fourth control signal to power up is detected in the sequence of image data and after exiting the clocks down mode if the clocks down mode is entered; and
exit, based on the sequence of image data, the one or more sleep modes according to an order of modes from lower to higher power usage and after exiting the powered down mode if the powered down mode is entered.

18. The device of claim 17, wherein the processor is configured to:
add the first control signal to power down in the sequence of image data according to an expected end time of a first active display period for displaying the display image data; and
add the fourth control signal to power up in the sequence of image data according to an expected start time of a second active display period for displaying next display image data;
add the second control signal to power down clocks in the sequence of image data according to an expected end time of an active display period for displaying the display image data; and
add the third control signal to power up clocks according to an expected start time of an active processing period for producing next display image data.

19. The device of claim 18, wherein the processor is configured to:
receive image frames in respective regular time intervals signaled by respective synchronization signals;
obtain the sequence of image data from the image frames in a respective time interval from the regular time intervals;
perform, in the respective time interval, write side activity including processing and storing the sequence of image data during the active processing period; and
perform, in the same respective time interval, read side activity to load the display image data to the light modulator for displaying during the first active display period.

20. The device of claim 16, wherein the one or more controllers are further configured to:
determine a length or a number of one or more gaps in the sequence of image data; and
enter a number of sleep modes in proportion to the length or number of the one or more gaps.
